(19) United States
(12) Patent Application Publication
(10) Pub. No.: US 2012/0315598 A1
(43) Pub. Date: Dec. 13, 2012

(54) DENTAL HANDPIECE

(76) Inventor: Paul H. KIM, Albany, NY (US)

(21) Appl. No.: 13/157,780

(22) Filed: Jun. 10, 2011

(51) Int. Cl. A61C 1/05

(52) U.S. Cl. 433/132

(57) ABSTRACT

A dental handpiece having a head comprising a headshell and an arm portion comprising an upper body and a lower body is presented. The head rotatably couples to the upper body, and the upper body pivotally couples to the lower body. An air turbine or a gear assembly may be included in the headshell whereby a dental bur attached to the air turbine or gear assembly protrudes from the headshell. In the case of using an air turbine, flexible tubing provides fluid to spin the air turbine, thereby rotating the bur. Alternatively, a flexible shaft may connect the gear assembly to a rotary source to communicate rotary motion to the bur.

### BACKGROUND OF THE INVENTION

1. Field of the Invention

Exemplary embodiments of the present invention relate to a dental handpiece and, more particularly, to a dental handpiece with a head rotatably coupled to an arm portion that provides a pivot motion between its upper and lower portions.

2. Discussion of the Background

Typical dental drills are small, high-speed drills used by dentists to remove tooth decay, particularly before application of a dental filling. Additionally, dental drills are commonly used to remove tooth enamel and plaque during tooth repair procedures and cleaning, respectively, as well as for use in finishing, polishing, and soft tissue drilling.

Low speed and high speed dental drills are available with rotational speeds of about 20,000 rpm and about 400,000 rpm, respectively. Various bits, called burs, attach to the head of the dental drill and are generally made of hard metal alloys, e.g., tungsten alloys, coated with carbide or diamond. The bur acts like a small, rotary file as the diamond or carbide particles that coat the metal of the bur remove materials from teeth such as plaque and damaged enamel. In the case of drilling, the hole may then be filled with a material to strengthen the tooth and prevent further damage.

Many dental drills are laborious to use due to low ergonomic economies. Further, some dental drills cause user fatigue, discomfort, or injury. Moreover, the working field may be obstructed from the user's view by the dental drill body or the hand of the user due to the configuration of the dental drill, and the difficulty associated with access to certain regions of the mouth or surfaces of teeth may be exacerbated by certain configurations of the dental drill or the lack of overall reconfigurability of some dental drills.

A void remains for a drill capable of low-speed or high-speed operating modes with higher ergonomic economy due to access to the working fields, regions of the mouth, and surfaces of the teeth.

### SUMMARY OF THE INVENTION

Exemplary embodiments of the present invention provide a reconfigurable dental handpiece.

Exemplary embodiments of present invention also provide a dental handpiece that may allow for enhanced ergonomic economy through access to the working field, regions of the mouth, and surfaces of the teeth.

Additional features of the invention will be set forth in the description which follows, and in part will be apparent from the description, or may be learned by practice of the invention.

An exemplary embodiment of the present invention discloses a dental handpiece that comprises a head having a headshell and an arm portion. The arm portion comprises an upper body and a lower body. The head rotatably couples to the upper body, and the upper body pivotally couples to the lower body.

An exemplary embodiment of the present invention also discloses a dental handpiece that comprises a head comprising a headshell, an arm portion comprising an upper body rotatably coupled to the headshell and a lower body pivotally coupled to the upper body, a gear assembly disposed in the headshell, a bur detachably coupled to a center portion of the gear assembly to protrude from the headshell, and a flexible drive shaft disposed in the upper body and the lower body of the arm portion and detachably coupled to the gear assembly to rotate the bur and.

An exemplary embodiment of the present invention further discloses a dental handpiece that comprises a head that comprises a headshell and a stem connected to the headshell. The dental handpiece also comprises an arm portion comprising an upper body rotatably coupled to the head, a retainer to affix the head to the arm portion, and an adjustable member disposed in the arm portion. The adjustable member engages the stem in a first position and disengages the head in a second position.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a dental handpiece according to a first exemplary embodiment of the present invention.

FIG. 2A is a longitudinal cross-section of a rotary air turbine assembly according to a first exemplary embodiment of the present invention showing a front view of the air turbine assembly with the head at 0°.

FIG. 2B is a longitudinal cross-section of a rotary air turbine assembly according to a first exemplary embodiment of the present invention showing a side view of the air turbine assembly with the head at 0°.

FIG. 3A is a plan view showing the bottom of a fluid channel body according to a first exemplary embodiment of the present invention with a bur positioned at 0°.

FIG. 3B is a plan view showing the bottom of a fluid channel body according to a first exemplary embodiment of the present invention with the bur positioned at φ-degrees.

FIG. 4A is a longitudinal cross-section of a dental handpiece according to a first exemplary embodiment of the present invention showing a side view of the dental handpiece with the head rotated by 0° and the upper body at 0°.

FIG. 4B is a longitudinal cross-section of a dental handpiece according to a first exemplary embodiment of the present invention showing a side view of the dental handpiece with the head rotated by 0° and the upper body pivoted through φ-degrees.

FIG. 5A is a longitudinal cross-section of a dental handpiece according to a first exemplary embodiment of the present invention showing a side view of the dental handpiece with the head rotated by 90° and the upper body at 0°.

FIG. 5B is a longitudinal cross-section of a dental handpiece according to a first exemplary embodiment of the present invention showing a side view of the dental handpiece with the head rotated by 90° and the upper body pivoted through φ-degrees.

FIG. 6 is a perspective view of a dental handpiece according to a second exemplary embodiment of the present invention.

FIG. 7A, FIG. 7B, FIG. 7C, FIG. 7D, FIG. 7E, and FIG. 7F show exploded perspective views of a dental headpiece according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on,” “connected to,” or “coupled to” another element, it can be directly on, directly connected, or directly coupled to the other element, or intervening elements may be present. In contrast, when an element is referred to as being “directly on,” “directly connected to,” or “directly coupled to” another element, there are no intervening elements present.

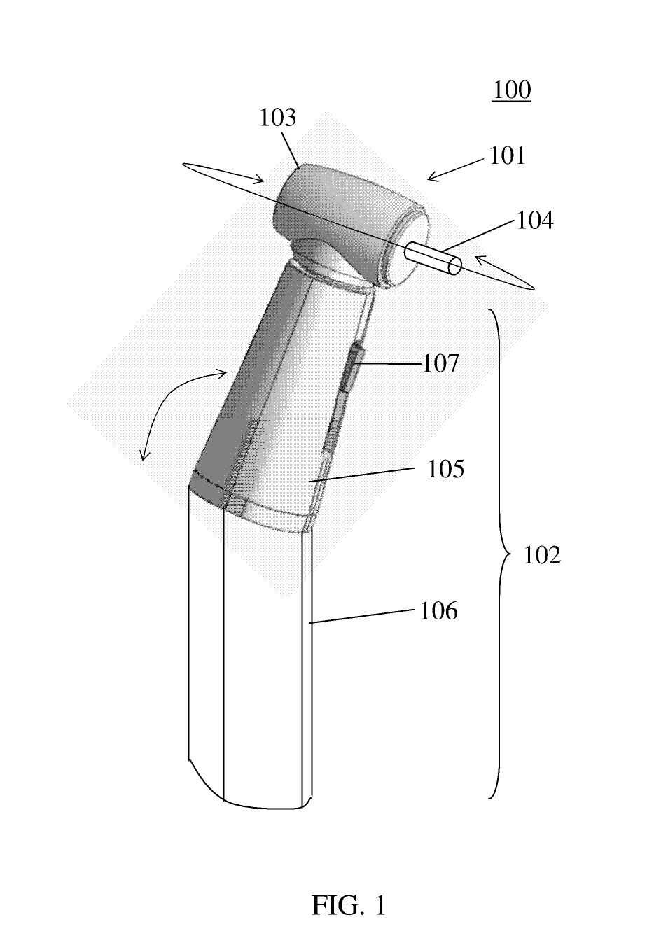

Referring to FIG. 1, a dental handpiece 100 according to a first exemplary embodiment of the present invention includes a head 101 rotatably attached to an arm portion 102. The head 101 has a headshell 103, and a bur 104 protrudes from the headshell 103 and detachably attaches to components within the headshell 103. The head 101 rotatably couples to an upper body 105 of the arm portion 102, and a lower body 106 of the arm portion 102 pivotally couples to the upper body 105. A rotation control slider 107 may be arranged in the upper body 105 to control the rotation of the head 101.

As indicated by the curved, double-headed arrows in FIG. 1, the head 101 rotates about the central axis of the upper body 105, and the upper body 105 pivots with respect to the lower body 106.

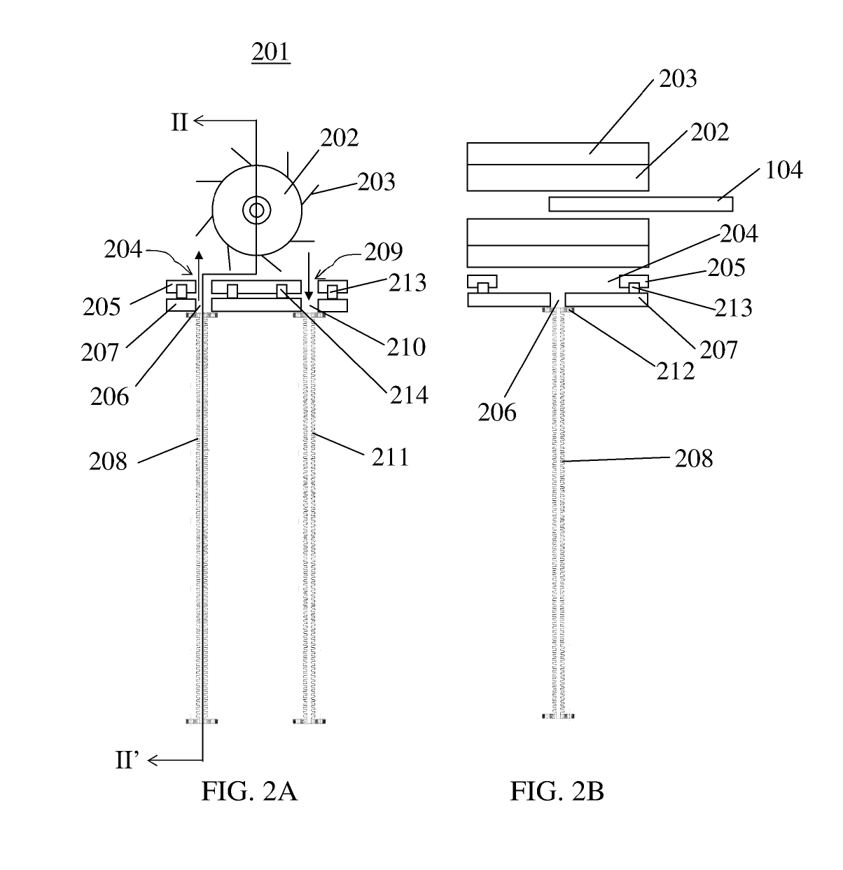

FIG. 2A shows exemplary components that may be housed within the headshell 103 and the arm portion 102. More particularly, a non-working surface of the bur 104 is arranged in the central portion of an air turbine 201 having a rotor 202 and blades 203 projecting from the rotor 202. The blades 203 are configured to interact with a flow of a fluid discharged through an input channel 204 of a fluid channel body 205. The fluid issues from an inlet channel 206 of a bulkhead 207. A inlet bellows tube 208 connects to the bottom surface of the fluid channel body and transmits the fluid to the inlet channel 206.

In response to the fluid impinging upon at least one of the blades 203, the rotor 202 spins about its central axis. The central axis is generally perpendicular, although not typically intersecting, to the center of the fluid flow from the input channel 204. Momentum transfer from the fluid causes the rotor 202 to spin. The fluid may be a gas or a liquid.

Since the air turbine is housed in a sealed portion of the headshell 103, the fluid traverses the outer surface of the rotor en route to the exit channel 209 of the fluid channel body 205 and then flows from the exit channel 209 through an exhaust channel 210 of the bulkhead 207 before flowing into an exhaust bellows tube 211. In this manner, the air turbine 201 may attain angular speeds ranging from 10,000 rpm to 400,000 rpm.

FIG. 2B shows a cross-section of the air turbine 201, the fluid channel body 205, the bulkhead 207, the inlet bellows tube 208, a flange 212, and an outer sealing member 213. For ease of explanation, the cross-section shown in FIG. 2B corresponds to a side view of these components generally taken along line II-IF in FIG. 2A with the exception that the blades 203, the fluid channel body 205, and the bulkhead 207 have been stylized and do not exactly match the cross-sections for these items along line II-II′.

The fluid flow is maintained through the inlet channel 206, the input channel 204, the exit channel 209, and the exhaust channel 210 without leakage or sparingly little leakage by the outer sealing member 213, and an inner sealing member 214.

The outer sealing member 213 and the inner sealing member 214 may be, for example, an elastomeric O-ring, a metal compression seal, or a spring-loaded polytetrafluoroethylene (PTFE) gasket. The outer sealing member 213 and the inner sealing member 214 may be materials that allow for dynamic seals during rotation between the fluid channel body 205 and the bulkhead 207. For example, in the case of a spring loaded PTFE gasket, the PTFE provides lubrication between the fluid channel body 205 and the bulkhead 207, thereby increasing momentum transfer efficiency during rotation of the fluid channel body 205. Further, since PTFE flows under some pressure, the PTFE acts to form a seal by filling small crevices between the fluid channel body 205 and the bulkhead 207 external to the inlet channel 206, the input channel 204, the exit channel 209, and the exhaust channel 210, thereby further reducing fluid leakage.

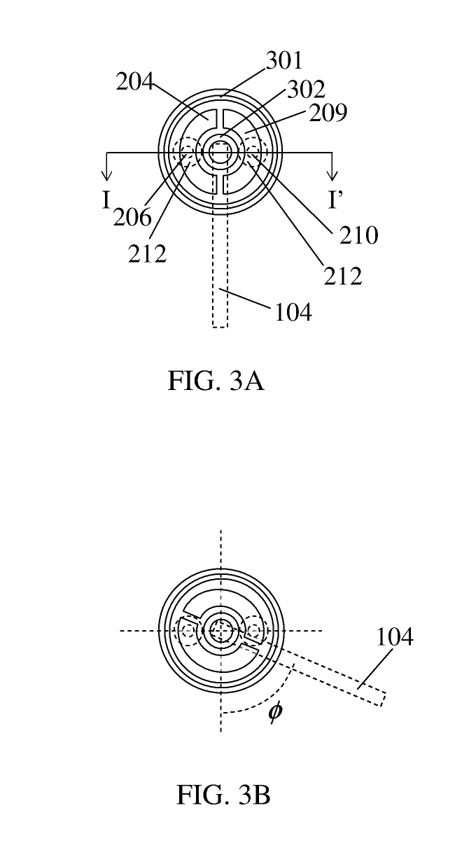

As shown in FIG. 3A and FIG. 3B, which show the bottom surface of the fluid channel body 205, an outer sealing gland 301 and an inner sealing gland 302 are arranged on the bottom surface of the fluid channel body 205. The outer sealing member 213 is disposed partially inside the outer sealing gland 301 as shown in FIG. 2A, and the inner sealing member 214 is partially disposed in the inner sealing gland 302.

A number of methods may be used to exert adequate pressure to cause the outer sealing member 213 and the inner sealing member 214 to form a seal between the bulkhead 207 and the fluid channel body 205. For example, an annular cap (not shown) may cover the periphery of the top surface of the fluid channel body 205 and attach to the bulkhead 207, which, in turn, may be connected to the upper body 105 of the arm portion 102 to preclude rotation of the bulkhead during rotation of the fluid channel body 205.

As shown in FIG. 3A, the input channel 204 and the exit channel 209 are semi-circular shaped; however, other suitable shapes such as a rectangular shape or a triangular shape may be used. The opposing termini of the input channel 204 and the exit channel 209 are positioned to increase the range of rotation of the fluid channel body 205 with respect to the inlet channel 206 and the exhaust channel 210. Since fluid flows into the input channel 204 from the inlet channel 206 and exits the headshell 103 via discharge into the exit channel 209 and the exhaust channel 210, the semi-circular shape of the input channel 204 and exit channel 209 may permit fluid flow without significantly obstructing the flow that would restrict the flow rate. Further, the angular rotational range of the fluid channel body 205 may be selected by matching the shape of the input channel 204 and the exit channel 209 to the diameters and shapes of the inlet channel 206 and the exhaust channel 210.

As shown in FIG. 1, the head 101 rotates about the central axis of the upper body 105 of the arm portion 102. Accordingly, the bur 104, the air turbine 201, and the fluid channel body 205 also rotate with the head 101. However, the bulkhead 207, the inlet bellows hose 208, the exhaust bellows hose 211, the upper body 105, and the lower body 106 are stationary with respect to the rotation of the head 101. Therefore, the bur 104 moves in response to a user repositioning the head 104 with respect to the arm portion 102. This may permit a user to select a head position that allows access to areas of the mouth and surfaces of the teeth and may reduce user fatigue and injury frequency.

Further to the rotation aspect of the head 101, the bur 104 is shown in FIG. 3A and FIG. 3B in a dashed line pattern. As explained above, the bur 104 and the fluid channel body 205 move synchronously. FIG. 3A corresponds to the case when the bur 104 is positioned perpendicular to line I-I′, which is a line running through the centers of the inlet channel 206 and the exhaust channel 210. As the head 101 rotates from the position shown in FIG. 3A to the position shown in FIG. 3B, the bur 104 rotates through an azimuthal angle φ, and the bulkhead 207 remains stationary so that the inlet channel 206 and the exhaust channel 102 do not rotate. Further, since the input channel 204 and the exit channel 209 overlap with the inlet channel 206 and the exhaust channel 210, respectively, throughout this angular range, the fluid flow may remain constant to the blades 203 of the air turbine 201. Additionally, given the semi-circular shape of the input channel 204 and the exit channel 209, the blades 203 may retain nearly the same fluid flow distribution along the length of the each blade 103 as the head 101 is positioned at various azimuthal angles, thereby conserving the angular speed of the air turbine 101.

Another aspect of the present exemplary embodiment beyond the rotational motion of the head 101 is the pivoting of the upper body 105 with respect to the lower body 106 of the arm portion 102.

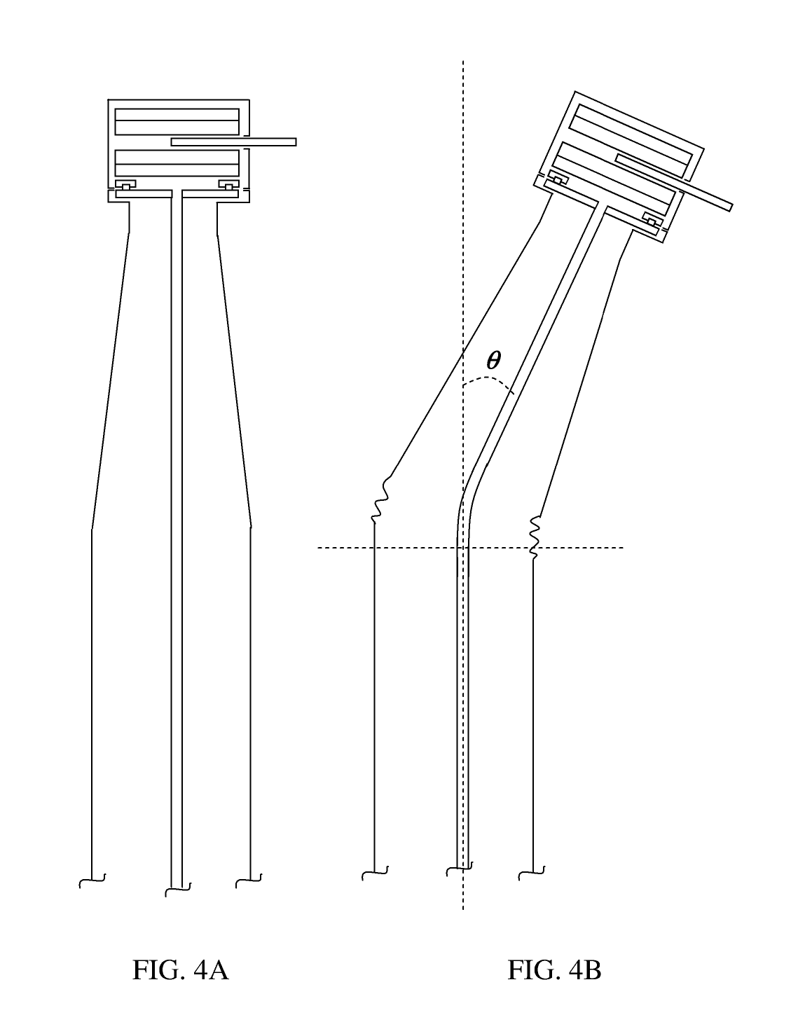

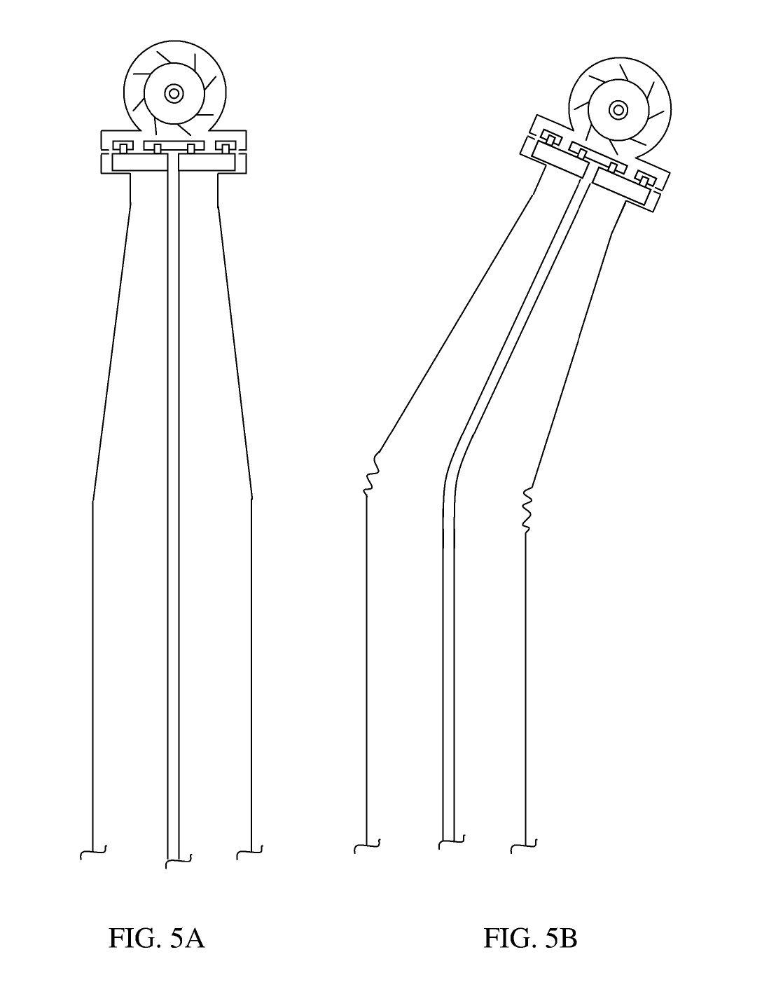

Referring to FIG. 4A, FIG. 4B, FIG. 5A, and FIG. 5B, FIG. 4A shows a cross-section of the dental handpiece according to the first exemplary embodiment with the head positioned at an azimuthal angle of 0° and the pivot angle of the upper body at 0°. Similarly, FIG. 4B shows the dental handpiece of the FIG. 4A with the head positioned at an azimuthal angle of 0° and the pivot angle of the upper body at approximately 35°. FIG. 5A shows the dental handpiece of FIG. 4A with the head positioned at an azimuthal angle of 90° and the pivot angle at 0°, and FIG. 5B shows the dental handpiece of FIG. 4A with the head positioned at an azimuthal angle of 90° and a pivot angle of approximately 35°.

As shown in FIG. 4A and FIG. 4B, the headshell 103 rotatably couples to the upper body 105, and the inlet bellows tube 208 extends from the bulkhead 207 and is disposed in the upper body 105 and the lower body 106. Exhaust bellows tube 211 also extends from the bulkhead 207 through the upper body 105 and the lower body 106.

The inlet bellows tube 208 and the exhaust bellows tube 211 are pliable, durable tubes that may be pressurized or evacuated to sub-atmospheric pressures while maintaining their structural integrity. Further, the inlet bellows tube 208 and the exhaust bellows tube 211 may be repeatedly bent without compromising their sidewalls. The structure of the sidewall of the inlet bellows tube 208 and the exhaust bellows tube 211 may be, for example, a bellows (i.e., accordion-like) construction that is either edge welded or hydraulically formed, a straight form, and similar formats and may be made of materials such as plastics or metals.

Comparing FIG. 4A and FIG. 4B, The upper body 105 pivots through pivot angle θ with respect to the lower body 106 at a joint (not shown) that couples the upper body 105 to the lower body 106. The joint may be a ball-and-socket joint but is not limited thereto due to the flexibility of the inlet bellows tube 208 and the exhaust bellows tube 211. The inlet bellows tube 208 and the exhaust bellows tube 211 may be arranged around the joint or may pass through a bore or similar structure in the joint. Portions of the joint that contact the inlet bellows tube 208 or the exhaust bellows tube 211 are preferably smooth, non-snagging, and non-binding. Moreover, the upper body 105 and the lower body 106 may provide fasteners to capture the inlet bellows tube 208 and the exhaust bellows tube 211 in order to secure them from being engaged by the joint during a pivot motion of the upper body 105. The pivot angle θ may range from 0° to ±120°.

FIG. 5A and FIG. 5B are similar to FIG. 4A and FIG. 4B, respectively, except the head 101 is rotated to an azimuthal angle of 90°. In this position, the inlet channel 206 and the exhaust channel 210 may be partially or completely obstructed by the material comprising the fluid channel body 205 between the input channel 204 and the exit channel 209. In the present exemplary embodiment, rotation of the head 101 by more than ±90° may cause the air turbine to spin in an opposite direction, which may be potentially useful in certain operations of the dental handpiece 100. Alternatively, the dental handpiece may have a lock-stop (not shown) that limits range of rotation of the head 101 to less than ±90°. Furthermore, the lock-stop may be disengaged to allow rotation of the head 101 through any azimuthal angle φ.

As an example, as shown in FIG. 1, a rotation control slider 107 may be disposed in the upper body 105. In a first position, the rotation control slider 107 locks the head 101 so that it cannot rotate. In a second position of the rotation control slider 107, the head 101 may rotate somewhat freely. Further, the rotation control slider 107 may have discrete, intermediate positions so that the head 101 may be rotated to a particular position corresponding to an intermediate position of the rotation control slider 107. For example, the head 101 may be positioned to discreet azimuthal angles 15°, 30°, 45°, and 60°, corresponding to four different intermediate positions of the rotation control slider 107.

Additionally, an arm portion bellows 401 may be integrally formed between the outer walls of the upper body 105 and the lower body 106 so that the dental handpiece 100 has a single-body construction. Alternatively, the arm portion bellows may be bonded or likewise attached to the upper body 105 and the lower body 106.

Moreover, instead of a bellows construction of the sidewall for the entire length of the inlet bellows tube 208 and the bellows exhaust tube 211, the inlet bellows tube 208 and the bellows exhaust tube 211 may have a flexible straight sidewall that extends from the bulkhead 207 and proximately to the joint between the upper body 105 and the lower body 106 where a bellows section may be disposed in the inlet bellows tube 208 and the bellows exhaust tube 211 followed by another flexible straight sidewall extending beyond the joint through the lower body 106. The intermediate bellows section and the straight portions may be made of the same materials as the inlet bellows tube 208 and the bellows exhaust tube 211 described above and may be a combination of materials, i.e., the intermediate bellows section and the straight portions may be made of different materials.

The headshell 103, the upper body 105, and the lower body 106 may be, for example, made of a plastic or a metal. The arm portion bellows 401 may by made of the same or similar materials as the upper body 105 and lower body 106.

The air turbine 201 may contain a metal, for example, aluminum. The fluid channel body 205 may be made of a plastic, ceramic, or metal, and the bulkhead 207 may be made of materials similar to the fluid channel body 205.

The lower body 106 couples to a fluid source. The lower body may have provisions such as plastic or metal tubing and fittings that connects the lower body 106 to a commercially available gas system so that the inlet bellow tube 208 and the exhaust bellows tube 211 connect to a supply and a return portions of the gas system.

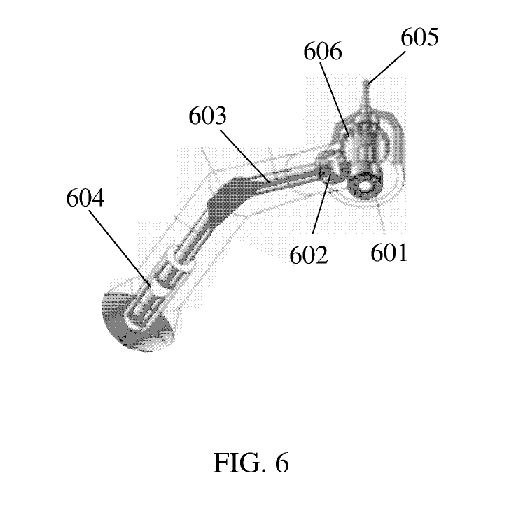

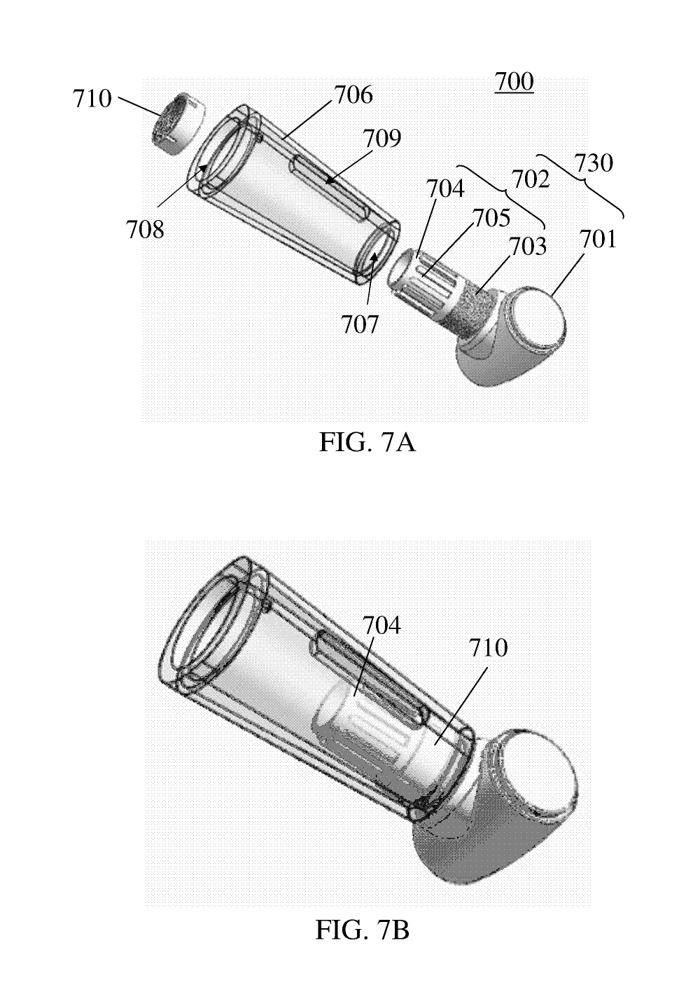

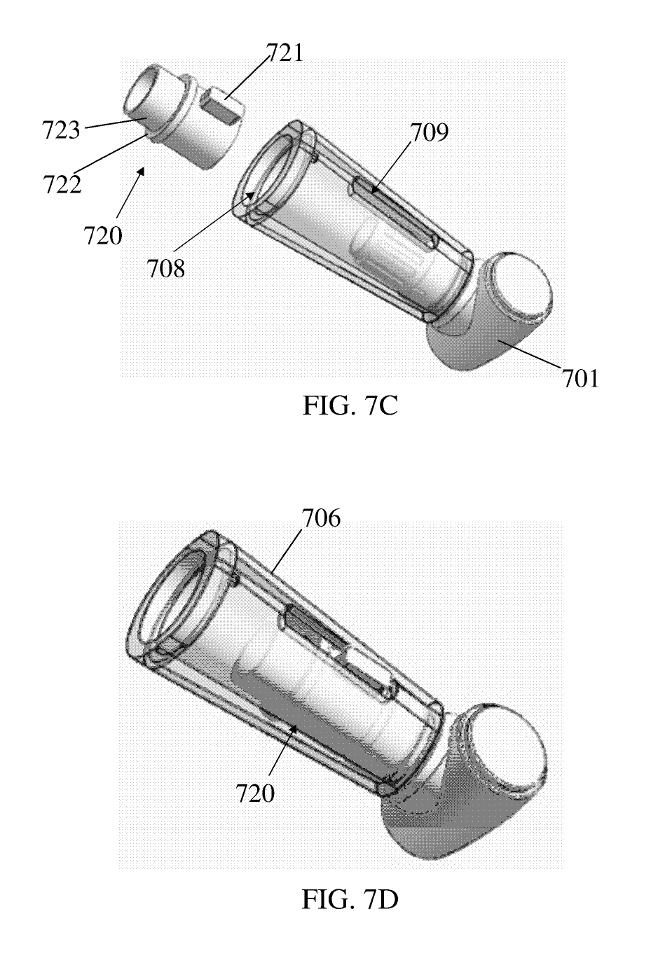

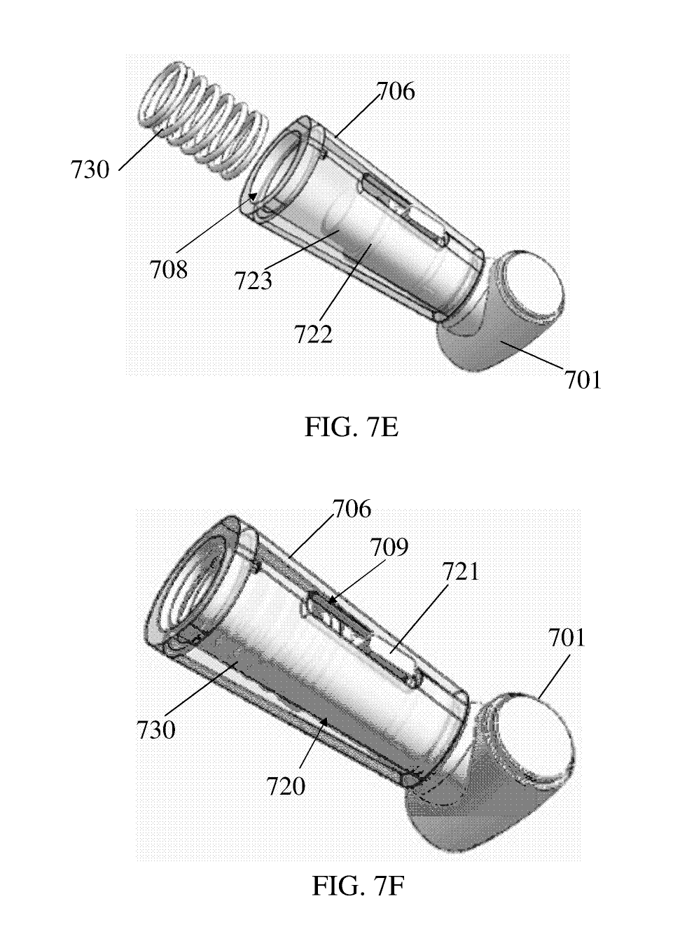

With reference to FIG. 6 and FIG. 7, in a second exemplary embodiment, instead of an air turbine, a head bearing and gear box with a bur latch 601 may be used in a dental handpiece. A bur 605 attaches to the head bearing, and a drive pinion 606 in the gear box interfaces with a crown wheel gear 602 at the end of a flexible drive shaft 603. The flexible drive shaft 603 extends from the head of the dental handpiece through the upper body and the lower body.

A drive coupling 604 disposed in the lower body couples to the flexible drive shaft 603. The drive coupling 604 connects to an external rotary source and translates rotary motion from the external rotary source to the bur 605 via the flexible drive shaft 603, the drive pinion 606, and the crown wheel gear 602.

The external rotary source may be an engine or motor that may be driven pneumatically such as by flowing gases or may be electrically driven.

As in the first exemplary embodiment, the head rotates with respect to the upper body, and the upper body pivots with respect to the lower body. Rotation of the head may be accomplished by a slider disposed on the upper body that, in a first position, allows the crown wheel gear of the flexible drive shaft to engage the drive pinion. In a second position of the slider, the crown wheel gear of the flexible drive shaft does not engage the drive pinion, thereby allowing free rotation of the head with respect to the upper body. The slider is then placed in the first position to engage the crown wheel gearing of the flexible shaft with the drive pinion.

In addition to the rotation of the head, the upper body pivots with respect to the lower body. Here, the pliability of the flexible drive shaft 603 allows for the upper body to pivot with respect to the lower body. As in the first exemplary embodiment, the present exemplary embodiment has a joint between the upper body and the lower body, and the flexible drive shaft 603 is protected from being snagged or obstructed by the joint by being directed away from the joint by positioning the joint an appropriate distance from the flexible drive shaft 603.

Next, another exemplary embodiment of a dental handpiece is described.

FIG. 7A, FIG. 7B, FIG. 7C, FIG. 7D, FIG. 7E, and FIG. 7F show exploded perspective views of a dental headpiece according to an exemplary embodiment of the present invention.

Referring to FIG. 7A and FIG. 7B, a dental handpiece 700 has a head 730 that includes a headshell 701 attached to a stem 702. The stem 720 has a threaded portion 703 and an extended portion 704 having a plurality of longitudinal notches 705. The upper body 706 of the handpiece 700 has a first opening 707 and a second opening 708 that oppose each other at the termini of the upper body 706, and a third opening 709 longitudinally disposed along the upper body 706. A threaded nut 710 attaches to the threaded portion 703 of the stem 702 after respective insertion of the threaded nut 710 and the stem 702 into the upper body 706 via the first and second openings 707 and 708. With the threaded nut 710 attached to the threaded portion 703, the headshell 701 is rotatably affixed to the upper body 706 so that the headshell 701 may not be separated from the upper body 706 unless the threaded nut 710 is removed from the threaded portion 703 of the stem 702.

Although the threaded nut 710 and threaded portion 703 are discussed as attaching the head 730 to the upper body 706, this discussion is merely illustrative. A different fastening system may be applied between the head 730 and the upper body 706. For example, the head portion may have a slot around the periphery of its body instead of the threaded portion 703, and a clip, for example, a retaining ring, may be introduced into the slot to rotatably attach the head 730 to the upper body 706.

As shown in FIG. 7C, to control rotation of the headshell 701 relative to the upper body 706, an arresting member 720 is inserted into the second opening 708 of the upper body 706 so that an adjustment projection 721 translates within the third opening 709. The arresting member 720 may be partially or fully hollow, and an inner portion of the arresting member 720 may have a complementary pattern of longitudinal notches (not shown) that complement the plurality of longitudinal notches 705 of the extended portion 704 of the stem 702. The arresting member 720 also has a stop 722 that allows, e.g., a spring (see FIG. 7E and FIG. 7F) to contact the arresting member 720. A first end 723 of the arresting member may have a smaller outer diameter than the stop 722.

FIG. 7D shows the arresting member 720 inserted into the upper body 706 with the plurality of longitudinal notches 705 of the extended portion 704 engaged by the complementary pattern of longitudinal notches of the arresting member 720.

Referring to FIG. 7E and FIG. 7F, a spring 730 inserts into the second opening 708 of upper body 706. The spring 730 has an inner diameter that is larger than the outer diameter of the first end 723 so that the spring fits around the first end 723. In contrast, the inner diameter of the spring 730 is smaller than the outer diameter of stop 722 so that the spring 730 seats against the stop 722 to contact the arresting member 720.

The spring 730 is held into place by, for example, a lock ring (not shown) so that the spring 730 is contained within the upper body 706 even when the upper body 706 is not attached to the lower body (not shown) of the dental handpiece. The spring 730 exerts force on the arresting member 720 so that the adjustment projection 721 remains in the position shown in FIG. 7F with the plurality of longitudinal notches 705 (see FIG. 7A) of the extended portion 704 engaging the complementary pattern of longitudinal notches of the arresting member 720. The adjustment projection 721 may be moved, i.e., translated, within the third opening 709 from its rest position (shown in FIG. 7F) toward the spring 730 to disengage the plurality of longitudinal notches 705 of the extended portion 704 and the complementary pattern of longitudinal notches of the arresting member 720 so that the headshell 701 may rotate with respect to the upper body 706. As the adjustment projection 721 translates toward the spring 730, potential energy increases in the spring 730, and more force exerts upon the arresting member 720. When the headshell 701 is set to the desired rotational position, the arresting member 720 moves toward the headshell 701 so that plurality of longitudinal notches 705 of the extended portion 704 re-engage the complementary pattern of longitudinal notches of the arresting member 720.

A lower body attaches to the upper body 706, and a bur (not shown) may be received in a receptacle of the headshell 701. The internal components may include any of the exemplary embodiments described above but are not limited thereto.

The spring 730, the upper body 706, the arresting member 720, and the headshell 701 may be made of plastic, metal, or any combination thereof.

Even though this exemplary embodiment is described as having an arresting member 720 with an adjustment projection 721 that translates within third opening 709 to determine whether the head 703 may rotate, the dental handpiece is not limited thereto. Alternatives to this configuration may be used. For example, the upper body may be equipped with a button that may be depressed to allow rotation of the head. When the button is released the head is maintained in a fixed position. Alternatively, the upper body may have a collar that may be retractably attached to the upper body or may be a rotary attachment. When the collar is in a first position, the collar may contact the head or an internal component of the head, for example, a mechanical brake of the upper body, to disallow rotation of the head. When the collar is moved (either by a rotation or a translation) to a second position, the collar does not contact the head or the internal component, and the head may be rotated into a different position with respect to the upper body.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A dental handpiece, comprising:
a head comprising a headshell; and
an arm portion comprising an upper body and a lower body,
wherein the head rotatably couples to the upper body.

2. The dental handpiece of claim 1, wherein the upper body pivotally couples to the lower body.

3. The dental handpiece of claim 1, wherein the headshell comprises:
an air turbine comprising a rotor and blades to spin in response to a fluid impingement on the blades, the blades disposed on the rotor to intercept a fluid flow; and
a bur detachably coupled to a center portion of the air turbine to protrude from the headshell.

4. The dental handpiece of claim 3, further comprising:
a fluid channel body disposed in the headshell and comprising an input channel and an exit channel; and
a bulkhead disposed in the upper body and comprising an inlet channel and an exhaust channel,
wherein the fluid flows through the inlet channel, the input channel, the exit channel, and the exhaust channel and impinges the blades of the air turbine during the flow.

5. The dental handpiece of claim 4, further comprising:
an first tube coupled to the inlet channel; and
an second tube coupled to the exhaust channel,
wherein the fluid flows from the first tube and exhausts through the second tube to spin the air turbine in a first direction;

6. The dental handpiece of claim 5, wherein the fluid flows from the second tube and exhausts through the first tube to spin the air turbine in a second direction.

7. The dental handpiece of claim 5, wherein the first tube and the second tube comprise a flexible material, the fluid channel body rotates with the headshell, and the bulkhead remains stationary with the upper body under rotation of the headshell.

8. The dental handpiece of claim 5, further comprising:
an outer sealing member disposed between the fluid channel body and the bulkhead; and
an inner sealing member disposed between the fluid channel body and the bulkhead,
wherein the outer sealing member is arranged proximal to a peripheral edge of the fluid channel body, and the inner sealing member is arranged proximal to the center of the fluid channel body; and
wherein the outer sealing member and the inner sealing member form a seal between the fluid channel body and the bulkhead.

9. The dental handpiece of the claim 8, further comprising:
a ball-and-socket joint to pivotally couple the upper body and the lower body of the arm portion.

10. A dental handpiece, comprising:
a head comprising a headshell;
an arm portion comprising an upper body rotatably coupled to the headshell and a lower body pivotally coupled to the upper body;
a gear assembly disposed in the headshell;
a bur detachably coupled to a center portion of the gear assembly to protrude from the headshell; and
a flexible drive shaft disposed in the upper body and the lower body and detachably coupled to the gear assembly to communicate rotation to the bur.

11. The dental handpiece of claim 10, wherein the gear assembly comprises a head bearing to which the bur detachably couples and a drive pinion coupled to the head bearing, and the flexible drive shaft comprises a crown wheel gear to detachably engage the drive pinion, and
wherein the flexible drive shaft couples to a rotary source to communicate a rotary motion to the bur.

12. A dental handpiece, comprising:
a head comprising:
a headshell; and
a stem connected to the headshell;
an arm portion comprising an upper body rotatably coupled to the head;
a retainer to affix the head to the arm portion; and
an adjustable member disposed in the arm portion,
wherein the adjustable member engages the stem in a first position and disengages the stem in a second position.

13. The dental handpiece of claim 12, wherein the head rotates with respect to the arm portion with the adjustable member in the second position, and the head does not rotate with respect to the arm position with the adjustable member in the first position.

14. The dental handpiece of claim 13, further comprising a spring to maintain the adjustable member in the first position so that the head does not rotate with respect to the arm portion.

15. The dental handpiece of claim 13, wherein the stem comprises at least one notch to engage a complementary notch pattern arranged in the adjustable member, wherein the head does not rotate with respect to the upper body with the at least one notch engaged with the complementary notch pattern, and the head rotates with respect to the upper body with the at least one notch disengaged from the complementary notch pattern.

16. The dental handpiece of claim 14, further comprising a fastener to retain the spring in the upper body,
wherein the adjustable member comprises a stop to contact the spring, the spring seats against the stop at a first end and seats against the fastener at a second end, and the upper body maintains the position of the fastener.

17. The dental handpiece of claim 12, further comprising a lower body pivotally coupled to the upper body;

18. The dental handpiece of claim 12, wherein the headshell comprises a receptacle to receive a bur.

19. The dental handpiece of claim 12, wherein the upper body comprises an opening disposed between a first end a second end of the upper body, the adjustable member comprises a projection, and the projection extends from the adjustable member and is arranged in the opening to translate between the first position and the second position.

20. The dental handpiece of claim 15, wherein the stem further comprises a receiver portion disposed between the at least one notch and the headshell, and the retainer contacts the receiver portion to rotatably affix the head to the arm portion.
